(19) United States
(12) Patent Application Publication
(10) Pub. No.: US 2009/0215936 A1
(43) Pub. Date: Aug. 27, 2009

(54) Coating for wood substrates and method of making same

(76) Inventor: Bo H. Gimvang, South Daytona, FL (US)

Correspondence Address: ROGERS TOWERS, P.A., 1301 RIVERPLACE BOULEVARD, SUITE 1500, JACKSONVILLE, FL, 32207, US

(21) Appl. No.: 12/380,162

(22) Filed: Feb. 24, 2009

Related U.S. Application Data
(60) Provisional application No. 61/031,689, filed on Feb. 26, 2008.

(51) Int. Cl. C09D 183/05; C08K 5/521

(52) U.S. Cl. 524/149

(57) ABSTRACT

A protective coating for an organic surface or substrate, the coating composition comprising a fluorophosphate ester, a fluorosurfactant such as a cationic fluoropolymer, polytetrafluoroethelene (PTFE), and deionized water. The coating may further comprise a silane having a solid content within a predetermined range.

This application claims the benefit of U.S. Provisional Patent Application Ser. No. 61/031,689, filed Feb. 26, 2008, the disclosure of which is incorporated herein by reference.

### BACKGROUND OF THE INVENTION

This invention relates generally to the field of protective coatings for various substrates and surfaces, and more particularly relates to such coatings beneficial to organic substrates and surfaces, and in particular wood substrates or surfaces, wherein the coating seals the substrate or surface and prevents decay and decomposition of the substrate or surface.

### SUMMARY OF THE INVENTION

The protective coating or sealant comprises a fluorophosphate ester, a fluorosurfactant such as a cationic fluoropolymer, polytetrafluoroethelene (PTFE), and deionized water. The coating may further comprise a silane having a solid content within a predetermined range.

The coating is prepared by first mixing water, fluorophosphate ester and the fluorosurfactant with PTFE to create a fluorinated urea poluol. In a second step, the fluorinated urea poluol is converted again into a tetraethylfluoromethylacrylate. In an alternative embodiment, a silane is added to the mixture to extend the effective life of the coating. The coating seals the organic substrate or surface when applied and allowed to dry, thereby repelling water and stains and preventing or inhibiting decay and decomposition of the substrate or surface.

### DETAILED DESCRIPTION OF THE INVENTION

A coating of a first preferred embodiment consisting essentially or comprising a composition having a fluorophosphate ester, a fluorosurfactant such as a cationic fluoropolymer, polytetrafluoroethelene (PTFE), and deionized water. The coating of the first preferred embodiment can also include a silane, such as polytetraethoxysilane having a solid content within a predetermined range, which will enable the coating to last for a great number of years. In one variation of the coating of the preferred embodiment, the coating can include fluorophosphate ester in an amount ranging between approximately five and fifteen percent by weight, the fluorosurfactant in an amount ranging between approximately five and fifteen percent by weight, polytetrafluoroethelene (PTFE) in an amount ranging between trace and approximately fifteen percent by weight, and deionized water in an amount ranging between approximately sixty five and ninety percent by weight. The silane can have a solid content ranging between approximately forty and forty-two percent active silane by weight.

The present invention further includes a method of making a coating, which in a preferred embodiment includes the steps of mixing fluorophosphate ester and the fluorosurfactant with polytetrafluoroethelene (PTFE) to create a fluorinated urea poluol. In a second step, the fluorinated urea poluol is converted again into a tetraethylfluoromethylacrylate, which is well suited for repelling water and stains. In either of the steps, one can add deionized water into the mixture to aid in the chemical reactions and conversions. An alternative to the method of the first preferred embodiment can also include the step of introducing a silane such as polytetraethoxysilane having a solid content within a predetermined range, which will enable the coating to last for a great number of years. Content ranges specified above for the coating are equally applicable in the method of making the coating.

As those of skill in the art will readily understand, the specific mixing times may be varied according to the mixing environment, temperature, humidity, air pressure, container characteristics and the desired functionality and/or features of the resulting coating, for example the desired hardness, chemical resistance, water repellant features and viscosity.

As a person skilled in the art will recognize from the previous detailed description and from the figures and claims, modifications and changes can be made to the preferred embodiments of the invention without departing from the scope of this invention defined in the following claims.

I claim:

1. A coating composition consisting essentially of a fluorophosphate ester, a fluorosurfactant, polytetrafluoroethelene, and deionized water.

2. The coating composition of claim 1, wherein said fluorosurfactant is a cationic fluoropolymer.

3. The coating composition of claim 1, further consisting essentially of a silane.

4. The coating composition of claim 3, wherein said silane is a polytetraethoxysilane.

5. The coating composition of claim 4, wherein said polytetraethoxysilane has a solid content ranging between approximately forty and forty-two weight percent active silane.

6. The coating composition of claim 2, further consisting essentially of a silane.

7. The coating composition of claim 6, wherein said silane is a polytetraethoxysilane.

8. The coating composition of claim 7, wherein said polytetraethoxysilane has a solid content ranging between approximately forty and forty-two weight percent active silane.

9. The coating composition of claim 1, wherein said fluorophosphate ester is present in an amount ranging between approximately five and fifteen percent by weight, the fluorosurfactant is present in an amount ranging between approximately five and fifteen percent by weight, polytetrafluoroethelene is present in an amount ranging between trace and approximately fifteen percent by weight, and deionized water is present in an amount ranging between approximately sixty five and ninety percent by weight.

10. The coating composition of claim 9, further consisting essentially of a silane having a solid content ranging between approximately forty and forty-two weight percent active silane.

11. The coating composition of claim 10, wherein said silane is a polytetraethoxysilane, said fluorosurfactant is a cationic fluoropolymer.

12. A coating composition comprising a fluorophosphate ester, a fluorosurfactant, polytetrafluoroethelene, and deionized water.

13. The coating composition of claim 12, wherein said fluorosurfactant is a cationic fluoropolymer.

14. The coating composition of claim 12, further comprising a silane.

15. The coating composition of claim 14, wherein said silane is a polytetraethoxysilane.

16. The coating composition of claim 15, wherein said polytetraethoxysilane has a solid content ranging between approximately forty and forty-two weight percent active silane.

17. The coating composition of claim 13, further comprising a silane.

18. The coating composition of claim 17, wherein said silane is a polytetraethoxysilane.

19. The coating composition of claim 18, wherein said polytetraethoxysilane has a solid content ranging between approximately forty and forty-two weight percent active silane.

20. The coating composition of claim 12, wherein said fluorophosphate ester is present in an amount ranging between approximately five and fifteen percent by weight, the fluorosurfactant is present in an amount ranging between approximately five and fifteen percent by weight, polytetrafluoroethelene is present in an amount ranging between trace and approximately fifteen percent by weight, and deionized water is present in an amount ranging between approximately sixty five and ninety percent by weight.

21. The coating composition of claim 20, further comprising a silane having a solid content ranging between approximately forty and forty-two weight percent active silane.

22. The coating composition of claim 21, wherein said silane is a polytetraethoxysilane, said fluorosurfactant is a cationic fluoropolymer.

23. A method of making a coating composition comprising the steps of mixing water, a fluorophosphate ester, a fluorosurfactant and polytetrafluoroethelene to create a fluorinated urea poluol, then converting said fluorinated urea poluol into a tetraethylfluoromethylacrylate.

24. The method of claim 23, further comprising the step of adding a silane.
